(19) United States
(12) Patent Application Publication
(10) Pub. No.: US 2013/0167429 A1
(43) Pub. Date: Jul. 4, 2013

(54) SAFE MOSQUITO KILLER

(71) Applicant: KUO-FONG TSENG, Tu-Cheng (TW)

(72) Inventor: KUO-FONG TSENG, Tu-Cheng (TW)

(73) Assignee: HON HAI PRECISION INDUSTRY CO., LTD., Tu-Cheng (TW)

(21) Appl. No.: 13/525,377

(22) Filed: Jun. 18, 2012

(30) Foreign Application Priority Data
Dec. 29, 2011 (TW) 100149482

(51) Int. Cl. A01M 1/00; G02B 26/08; G01S 15/88

(52) U.S. Cl. 43/132.1

(57) ABSTRACT

A mosquito killer includes a sonar module to detect a location of a mosquito, a low-power laser gun to emit a laser beam, a first reflecting mirror, a second reflecting mirror, and a controller. The first reflecting mirror reflects the laser beam to the second reflecting mirror. The second reflecting mirror is rotatable, and the controller is configured for receiving the location of the mosquito from the sonar module and controlling the second reflecting mirror to rotate to aim the laser beam to kill the mosquito.

### BACKGROUND

1. Technical Field

The present disclosure relates mosquito killers and, particularly, to a safe mosquito killer.

2. Description of Related Art

Many mosquito killing products are electronic and attract mosquitoes by emitting ultraviolet (UV) light and then trap and kill the mosquito using adhesive and electric shock. However, the UV light is potentially harmful to humans.

Therefore, it is desirable to provide a mosquito killer, which can overcome the above-mentioned shortcomings

### BRIEF DESCRIPTION OF THE DRAWINGS

FIG. 1 is a schematic view of a mosquito killer according to an embodiment.

FIG. 2 is a schematic view of a mosquito killer according to another embodiment.

### DETAILED DESCRIPTION

Embodiments of the disclosure will be described in detail, with reference to the accompanying drawings.

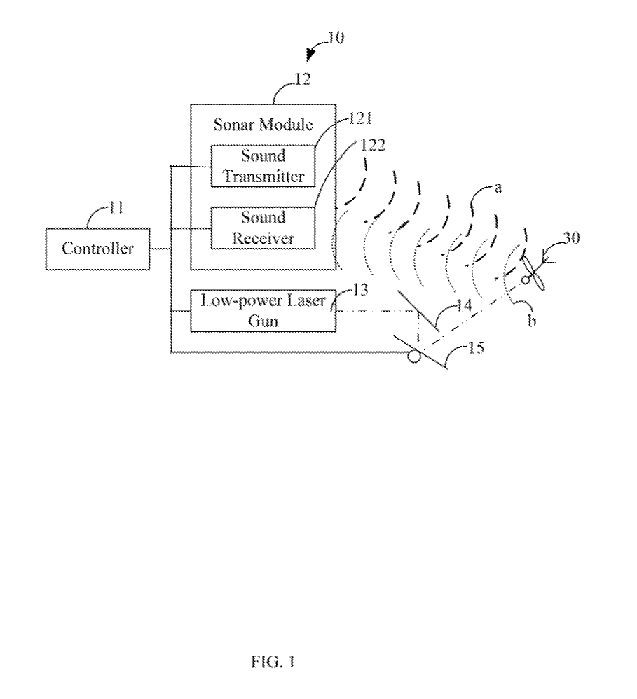

Referring to FIG. 1, a mosquito killer 10, according to an embodiment, includes a controller 11, a sonar module 12, a low-power laser gun 13, a first reflecting mirror 14, and a second reflecting mirror 15.

The controller 11 is connected to and controls the sonar module 12, the low-power laser gun 13, and the second reflecting mirror 15 to kill mosquitoes.

The sonar module 12 is configured to detect a location of a mosquito 30 under the control of the controller 11. In this embodiment, the sonar module 12 includes a sound transmitter 121 and a sound receiver 122. The controller 11 is configured for activating the sound transmitter 121 and the sound receiver 122. The sound transmitter 121 is configured for generating and transmitting a pulse of sound (labeled as “a” in FIG. 1). The sound receiver 122 is configured for receiving a reflection of the pulse (labeled as “b”) to determine the location of the mosquito 30. In practice, the pulse of sound is concentrated into a beam to increase effective range, and the sound transmitter 121 and the sound receiver 122 can be driven to sweep an area.

The low-power laser gun 13 is configured for emitting a laser beam to kill the mosquito 30 under control of the controller 13. Specifically, the controller 11 is configured for receiving the location of the mosquito 30 from the sonar module 12 and signaling the low-power laser gun 13 to emit the laser beam. In other embodiments, the low-power laser gun 13 can continuously emit the laser beam. The low-power laser gun 13 may include an infrared laser diode to emit the laser beam.

The first reflecting mirror 14 is configured for reflecting the laser beam to the second reflecting mirror 15.

The second reflecting mirror 15 is configured for reflecting the laser beam to the mosquito 30 under the control of the controller 11. In this embodiment, the second reflecting mirror 15 is rotatable and the controller 11 controls the second reflecting mirror 15 to rotate so as to aim at the mosquito 30 according to the location of the mosquito 30 received from the sonar module 12.

As such, the mosquito killer 10 avoids using UV light and thus is safe for humans.

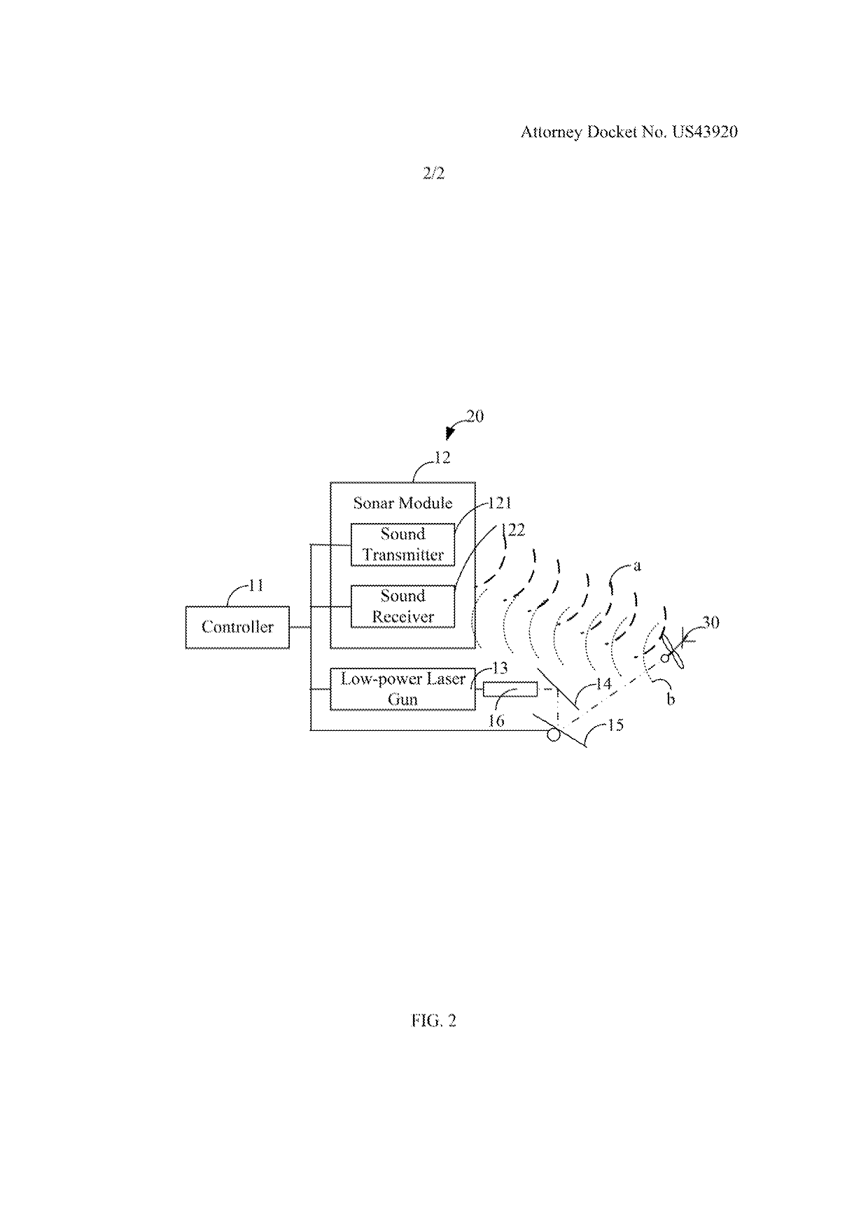

Referring to FIG. 2, a mosquito killer 20, according to another embodiment, is essentially similar to the mosquito killer 10 but further includes a optical fiber module 16 to direct the laser beam to the first reflecting mirror 14, thus avoiding loss of power of the laser beam.

Particular embodiments are shown here and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A mosquito killer, comprising:
a sonar module to detect a location of a mosquito;
a low-power laser gun to emit a laser beam;
a first reflecting mirror;
a second reflecting mirror; and
a controller, the first reflecting mirror reflecting the laser beam to the second reflecting mirror, the second reflecting mirror being rotatable, the controller being configured for receiving the location of the mosquito from the sonar module and controlling the second reflecting mirror to rotate to aim the laser beam to the mosquito.

2. The mosquito killer of claim 1, wherein the sonar module comprises a sound transmitter and a sound receiver, the sound transmitter is configured for emitting a pulse of sound, and the sound receiver is configured for receiving a reflection of the pulse.

3. The mosquito killer of claim 1, wherein the sonar module is activated by the controller.

4. The mosquito killer of claim 1, wherein the low-power laser gun comprises an infrared laser diode to emit the laser beam.

5. The mosquito killer of claim 1, wherein the low-power laser is activated to emit the laser beam by the controller when the controller receives the location of the mosquito.

6. The mosquito killer of claim 1, further comprising an optical fiber module to direct the laser beam from the low-power laser gun to the first reflecting mirror.
